(19) United States
(12) Patent Application Publication
(10) Pub. No.: US 2026/0339584 A1
(43) Pub. Date: Oct. 29, 2026

(54) SERVER, METHOD EXECUTED BY SERVER, AND COMMUNICATION SYSTEM

(71) Applicant: BROTHER KOGYO KABUSHIKI KAISHA, Nagoya (JP)

(72) Inventor: Naoto SHIRAGA, Nagoya (JP)

(21) Appl. No.: 19/659,420

(22) Filed: Apr. 27, 2026

(30) Foreign Application Priority Data
Apr. 28, 2025 (JP) 2025-074785

(51) Int. Cl. G06F 3/12

(52) U.S. Cl. CPC G06F 3/1288; G06F 3/1204; G06F 3/1238

(57) ABSTRACT

A server may include a memory configured to store, for each of a plurality of image processing devices, unique identification information assigned by a vendor of the image processing device and device identification information identifying the image processing device in association with each other, and store, for each of the plurality of image processing devices, user account information assigned by a vendor of the image processing device. The server may receive specific unique identification information from the terminal device and specific device identification information from a specific image processing device. In a case where the specific unique identification information and the specific device identification information are stored in the memory in association with each other, the server may send service screen information representing a service screen for subscribing to a service to the terminal device.

### REFERENCE TO RELATED APPLICATIONS

This application claims priority to Japanese Patent Application No. 2025-074785 filed on Apr. 28, 2025. The entire content of the priority application is incorporated herein by reference.

### BACKGROUND ART

It is known that a user uses a terminal device to register information for receiving a service related to a printer with a server.

### SUMMARY

This specification discloses art that allows to improve user convenience of an image processing device.

A server disclosed herein may include a memory configured to store, for each of a plurality of image processing devices, unique identification information assigned by a vendor of the image processing device and device identification information identifying the image processing device in association with each other, and store, for each of the plurality of image processing devices, user account information assigned by a vendor of the image processing device, and a controller. The controller may be configured to, in a case where specific unique identification information is inputted to a terminal device, receive the specific unique identification information from the terminal device. The controller may be configured to, in a case where a predetermined operation is executed on a specific image processing device among the plurality of image processing devices, receive specific device identification information identifying the specific image processing device from the specific image processing device. The controller may be configured to, in a case where the specific unique identification information is received from the terminal device, the specific device identification information is received from the specific image processing device, and the specific unique identification information and the specific device identification information are stored in the memory in association with each other, send service screen information representing a service screen for subscribing to a service provided by the server to the terminal device.

According to the above configuration, the server stores the unique identification information and the device identification information in association with each other for each of the plurality of image processing devices. The server also stores the user account information assigned by the vendor of the image processing device for each of the plurality of image processing devices. Therefore, the server can send the service screen information to the terminal device without receiving registration of the user account information from the user. In other words, the user can subscribe to the service without conducting work for registering the user account information with the server. This can improve user convenience.

A computer-readable storage medium storing computer-readable instructions for realizing the above-described server is also novel and useful. A method executed by the server is also novel and useful. Also, a communication system comprising two or more of the following devices: a server, a terminal device, and a function executing device is novel and useful.

### BRIEF DESCRIPTION OF DRAWINGS

FIG. 1 is a configurational diagram of a communication system.

FIG. 2 is a sequence diagram of processing of Case A.

FIG. 3 is a sequence diagram of continuation of FIG. 2.

FIG. 4 is a sequence diagram of processing of Case B.

FIG. 5 is a sequence diagram of a first comparative example.

FIG. 6 is a sequence diagram of a second comparative example.

### DESCRIPTION

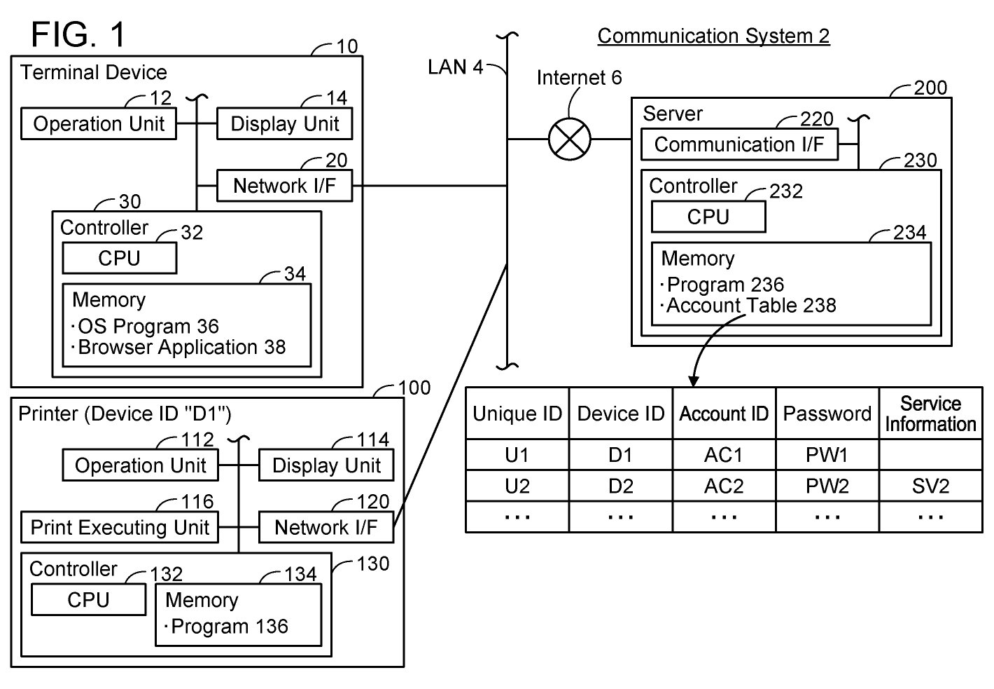

### Configuration of Communication System 2: FIG. 1

As shown in FIG. 1, a communication system 2 comprises a terminal device 10, a printer 100, and a server 200. The terminal device 10 and the printer 100 are connected to a Local Area Network (LAN) 4. The LAN 4 may be either a wired LAN or a wireless LAN. The LAN 4 is connected to the Internet 6. The server 200 is installed on the Internet 6. The terminal device 10 and the printer 100 are configured to communicate with the server 200 via the LAN 4 and Internet 6.

### Configuration of Terminal Device 10

The terminal device 10 may be a portable terminal device such as a cell phone, a smart phone, a PDA, a tablet PC, etc. The terminal device may also be a stationary terminal device such as a desktop PC, a laptop PC, etc. The terminal device 10 comprises an operation unit 12, a display unit 14, a network interface 20, and a controller 30. Each of the modules 12 to 30 is connected to a bus line.

The operation unit 12 is a user interface that enables a user to input various information to the terminal device 10. The operation unit 12 comprises, for example, a touch screen (touch panel) for displaying software keys (i.e., operation objects), hardware keys, or both. The hardware keys are, for example, buttons, switches, etc. The display unit 14 is a display or panel for displaying various information. The panel may or may not be a touch screen (touch panel). The panel may be, for example, an LCD panel or an OLED panel. The network interface 20 is connected to the LAN 4.

The controller 30 comprises a CPU 32 and a memory 34. The memory 34 comprises a main storage and an auxiliary storage. Although this is an example, the main storage includes RAM and cache memory, for example. Although this is an example, the auxiliary storage device may be ROM, flash memory, Solid State Drive (SSD), Hard Disk Drive (HDD), or a combination thereof. The auxiliary storage device of memory 34 stores an OS program 36 and a browser application 38. The CPU 32 realizes various processing according to each program 36, 38, for example, loaded from the auxiliary storage to the main storage.

The OS program 36 controls basic operation of the terminal device 10. The browser application 38 can access a web server on the Internet 6 and display web pages, for example.

### Configuration of Printer 100

The printer 100 is a peripheral device configured to perform a printing function, e.g., a peripheral device of the terminal device 10. The printer 100 has a device ID “D1”, which is information identifying the printer 100. The printer 100 comprises an operation unit 112, a display unit 114, a print executing unit 116, a network interface 120, and a controller 130. Each of the modules 112 to 130 is connected to a bus line.

The operation unit 112, display unit 114, and network interface 120 are realized in various configurations similar to the modules 12, 14, and 20 of the terminal device 10, respectively. The print executing unit 116 comprises an inkjet, electrophotographic, or thermal printing engine. The inkjet printing engine comprises a print head that ejects ink droplets. The electrophotographic printing engine comprises a photoreceptor and an exposure device that exposes the photoreceptor by emitting light. Thermal printing engine comprises a print head that emits heat by means of a heater.

The controller 130 comprises a CPU 132 and a memory 134. The memory 134 is realized in various configurations similar to the memory 34 of the terminal device 10 and stores a program 136. The CPU 132 realizes various processing according to the program 136 loaded from the auxiliary storage to the main storage.

### Configuration of Server 200

The server 200 is installed on the Internet 6 by a vendor of the printer 100. The server 200 may be a physical server, a virtual server in a cloud, a virtual machine, for example. The server 200 may be a single server or a collection of multiple servers. The server 200 may be a server on an intranet or a cloud server on the Internet 6. In a modification, the server 200 may be installed on the Internet 6 by a different entity than the vendor. In another modification, the vendor may not prepare hardware of the server 200 hardware on their own, but may use an environment provided by an external cloud computing service. In this case, the vendor may realize the server 200 by preparing a program for the server 200 and installing it in the environment described above. In this modification, an aspect in which the server 200 is a physical server will be described as an example.

The server 200 realizes service(s) for various products manufactured by the vendor of the printer 100. The service in the present embodiment is a flat-rate printing service. The flat-rate printing service is a service that allows printing on print media of less than an upper-limit number of sheets within a predetermined period, such as one month, for a flat rate. If printing is performed in excess of the upper-limit number of sheets in the predetermined period, an excess fee is charged, which is obtained by multiplying the excess number of sheets by a unit charge.

In a modification, the service may not be limited to the flat-rate printing service, but an automatic dispatch service for consumables, a print material download service, a maintenance service may be employed for example. The automatic dispatch service is a service that automatically dispatches consumables when the timing for dispatching the consumables arrives. The print material download service is a service that allows the downloading of image(s) to be printed. The maintenance service is a service that remotely performs maintenance on the printer or sends worker(s) to a printer's installation location.

The server 200 comprises a communication interface 220 and a controller 230. The modules 220 and 230 are connected to a bus line. The communication interface 220 is connected to the Internet 6. The controller 230 comprises a CPU 232 and a memory 234. The memory 234 is realized in various configurations similar to the memory 34 of the terminal device 10 and stores a program 236. The CPU 232 realizes various processing according to the program 236 loaded from the auxiliary storage to the main storage.

The memory 234 further stores an account table 238. The account table 238 stores a unique ID, a device ID, an account ID, a password, and service information for each of a plurality of printers manufactured by the vendor.

The unique ID is identification information pre-assigned by the vendor for each individual printer. The account ID and password are account information for using the server 200. In the following, the account ID and password may be described collectively as “account information”. Here, in the present embodiment, the account information is pre-assigned by the vendor for each individual printer and stored in advance in the account table 238. The timing at which the respective information including the unique ID, the device ID, and the account information is stored in the account table 238 is not particularly limited. For example, before a certain printer is shipped, the respective information corresponding to the certain printer may be stored in the account table 238. For example, when a certain printer is shipped and purchased by a user, the respective information corresponding to the certain printer may be stored in the account table 238. In general terms, the respective information corresponding to a certain printer only needs to be stored in the account table 238 before the certain printer is used by the user for the first time.

The service information is information that is stored in the account table 238 in response to a user of a printer subscribing to a service, and is necessary to receive that service. The service information includes, for example, the name of a subscribed service, the name of a subscribed service plan, a user's name, a user’s address, and payment information of the user.

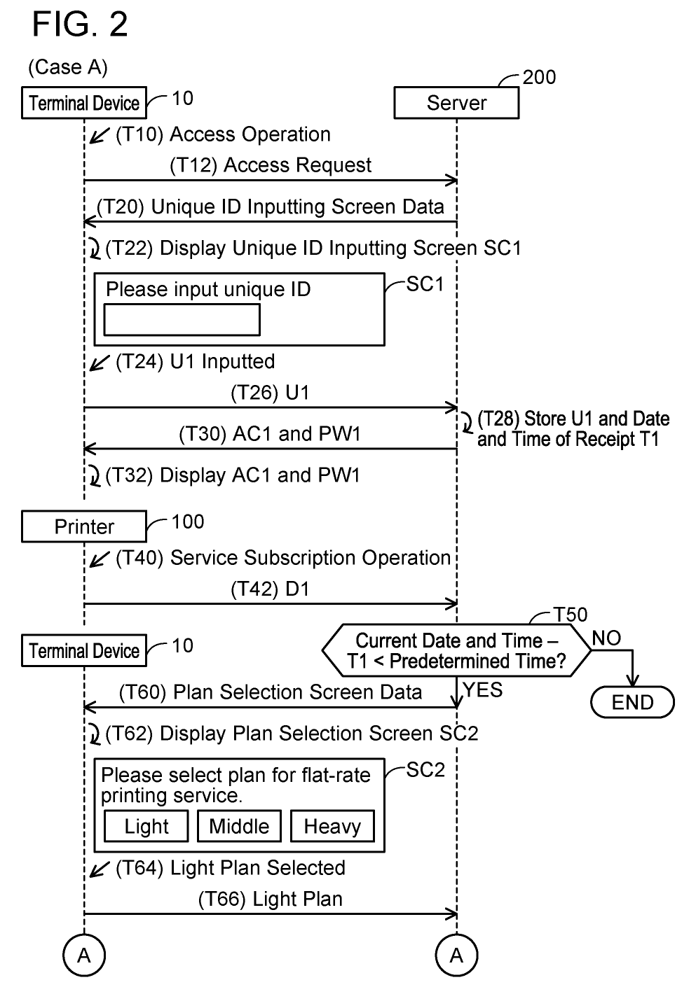

### Processing of Case A: FIG. 2

The processing executed by each of the devices 10, 100, 200 will be described below with reference to FIG. 2. In the following, when describing the content of the processing executed by the CPU of each device, the CPU will not be described as the subject of the processing, but the device will be described as the subject of the processing. The communication executed between the terminal device 10, the printer 100, and the server 200 is performed via the network interfaces 20, 120, and the communication interface 220. For this reason, the descriptions “via the network interface 20 (or 120)” and “via the communication interface 220” will be omitted in the following description.

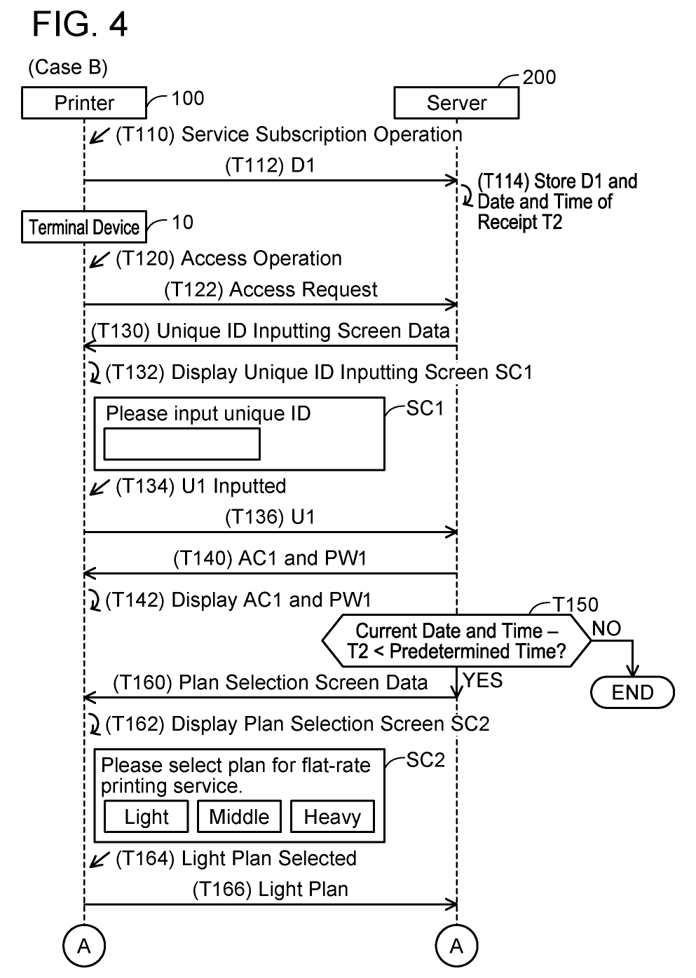

The processing in FIG. 2 is the processing performed by each of the devices 10, 100, 200 to enable a user who has purchased the printer 100 to subscribe to the flat-rate printing service. In particular, Case A is a case in which the user operates the terminal device 10 first, and then operates the printer 100. Case B in FIG. 4, to be described below, is a case in which the user operates the printer 100 first and then operates the terminal device 10.

The terminal device 10 receives an operation to launch the browser application 38 from the user. This allows the browser application 38 to realize the subsequent processing of the terminal device 10. Next, the terminal device 10 receives an access operation to access the server 200 in T10. The access operation is, for example, an operation to search for the server 200 using a search engine and select the server 200 from the search result. Also, the access operation is, for example, directly inputting a URL of the server 200 into the browser application 38. When the terminal device 10 receives the access operation, the terminal device 10 sends an access request to the server 200 in T12.

The server 200 receives the access request from the terminal device 10 in T12. In this case, the server 200 sends unique ID inputting screen data representing a unique ID inputting screen SC1 to the terminal device 10 in T20.

When the terminal device 10 receives the unique ID inputting screen data from the server 200 in T20, the terminal device 10 displays the unique ID inputting screen SC1 on the display unit 14 in T22. The unique ID inputting screen SC1 includes an input field for inputting a unique ID.

The user of the printer 100 is notified of the unique ID when the user purchases the printer 100. For example, the unique ID is notified to the user by an e-mail sent from a dealer of the printer 100 to the user's e-mail address. Also, for example, the unique ID is written on a form enclosed with the printer 100, and the unique ID is thereby notified to the user. The terminal device 10 receives an operation to input a unique ID “U1” assigned to the printer 100 from the user in T24. In this case, the terminal device 10 sends the unique ID “U1” to the server 200 in T26.

The server 200 receives the unique ID “U1” from the terminal device 10 in T26. In this case, the server 200 first checks whether the server 200 has already received a device ID “D1” associated with the unique ID “U1” from the printer 100. Specifically, the server 200 first specifies the device ID “D1” associated with the unique ID “U1” from the account table 238. Then, the server 200 determines whether the server 200 has already received the already specified device ID “D1” from the printer 100. More specifically, the server 200 determines whether or not the device ID “D1” has been temporarily stored in the memory 234. In this Case A, the server 200 has not already received the device ID “D1”. In this case, the server 200 temporarily stores the unique ID “U1” and a date and time T1 when the unique ID “U1” was received in association with each other in the memory 234 in T28.

Next, the server 200 specifies account information “AC1” and “PW1” associated with the unique ID “U1” from the account table 238. The server 200 then sends the account information “AC1” and “PW1” to the terminal device 10 in T30.

The terminal device 10 receives the account information “AC1” and “PW1” from the server 200 in T30. In this case, the terminal device 10 displays the account information “AC1” and “PW1” on the display unit 14 in T32. This allows the user to acknowledge the account information “AC1” and “PW1”. Here, the account information “AC1” and “PW1” are not determined by the user, but assigned by the vendor. Therefore, it is difficult for the user to remember the account information “AC1” and “PW1” just by looking at them. For this reason, the user may write them down or take a picture of them to store them for later use.

Next, the user moves closer to the printer 100 and operates the printer 100. In particular, the user causes the printer 100 to display a screen for subscribing to service(s) and selects the flat-rate printing service from that screen. In this way, the printer 100 receives an operation to select the flat-rate printing service, i.e., a service subscription operation, from the user in T40. In this case, the printer 100 sends the device ID “D1” of the printer 100 to the server 200 in T42.

The server 200 receives the device ID “D1” from the printer 100 in T42. In this case, the server 200 first checks whether the server 200 has already received the unique ID “U1” associated with the device ID “D1” from the terminal device 10. Specifically, the server 200 specifies the unique ID “U1” associated with the device ID “D1” from the account table 238. Then, the server 200 determines whether the server 200 has already received the identified unique ID “U1” from the terminal device 10. More specifically, the server 200 determines whether or not the unique ID “U1” has been temporarily stored in the memory 234. In this Case A, in T28, the unique ID “U1” is already temporarily stored in the memory 234. That is, the server 200 has already received the unique ID “U1”. In this case, the server 200 proceeds to T50.

In T50, the server 200 determines whether a difference time between the current date and time and the received date and time T1 (date and time of receipt T1) stored in T28 is smaller than a predetermined time. That is, the server 200 determines whether the device ID “D1” was received before the predetermined time elapsed since the unique ID “U1” was received. When the difference time is equal to or less than the predetermined time, the server 200 determines YES in T50 and proceeds to T60. In this case, the server 200 sends plan selection screen data representing a plan selection screen SC2 to the terminal device 10 in T60. Contrary to this, when the difference time is greater than the predetermined time, the server 200 determines NO in T50 and ends the processing without executing the series of processing from T60. In this case, the server 200 erases the unique ID “U1” and the received date and time T1 stored in T28 from the memory 234.

When a long time is required from the reception of the unique ID “U1” to the reception of the device ID “D1”, i.e., in case of NO in T50, the server 200 does not execute the series of processing from T60. In other words, the server 200 employs a timeout. For example, a situation where the processing from T10 to T32 is executed due to a first user who purchased the printer 100 operating the terminal device 10 will be assumed. However, the first user does not wish to subscribe to the flat-rate service and does not perform the operation of T40. If the server 200 is configured not to employ a timeout, a second user, who is different from the first user, could subscribe to the flat-rate printing service against the intention of the first user due to accidentally executing the operation of T40. In the present embodiment, since the server 200 employs a timeout, such an event can be suppressed from occurring.

In a modification, the server 200 may not perform the processing of T50 when receiving the device ID “D1” from the printer 100. That is, the server 200 may not perform the processing of T50 triggered by T42. For example, after a predetermined time elapses since the unique ID “U1” was stored in T28, the server 200 may erase the unique ID “U1” and the received date and time T1 from the memory 234. This configuration can also suppress an event in which the user is made to subscribe to the flat-rate printing service against the user's intention from occurring.

When the terminal device 10 receives the plan selection screen data from the server 200 in T60, the terminal device 10 displays the plan selection screen SC2 on the display unit 14 in T62. The plan selection screen SC2 is a screen for selecting a service plan from among three service plans for the flat-rate printing service. The three service plans include a Light plan, a Middle plan, and a Heavy plan. As to a basic fee of a predetermined period such as one month, the Light plan has the lowest basic fee and the Heavy plan has the highest basic fee. As to the upper-limit number of sheets of a predetermined period, the Light plan has the smallest number and the Heavy plan has the largest number. As to the excess fee for printing in excess of the upper-limit number of sheets, the Light plan has the lowest price and the Heavy plan has the highest price.

The user selects one of the three service plans based on frequency of use of the printer 100 for example. In this Case A, the terminal device 10 receives the selection of the Light plan from the user in T64. In this case, the terminal device 10 sends information indicating the Light plan to the server 200 in T66.

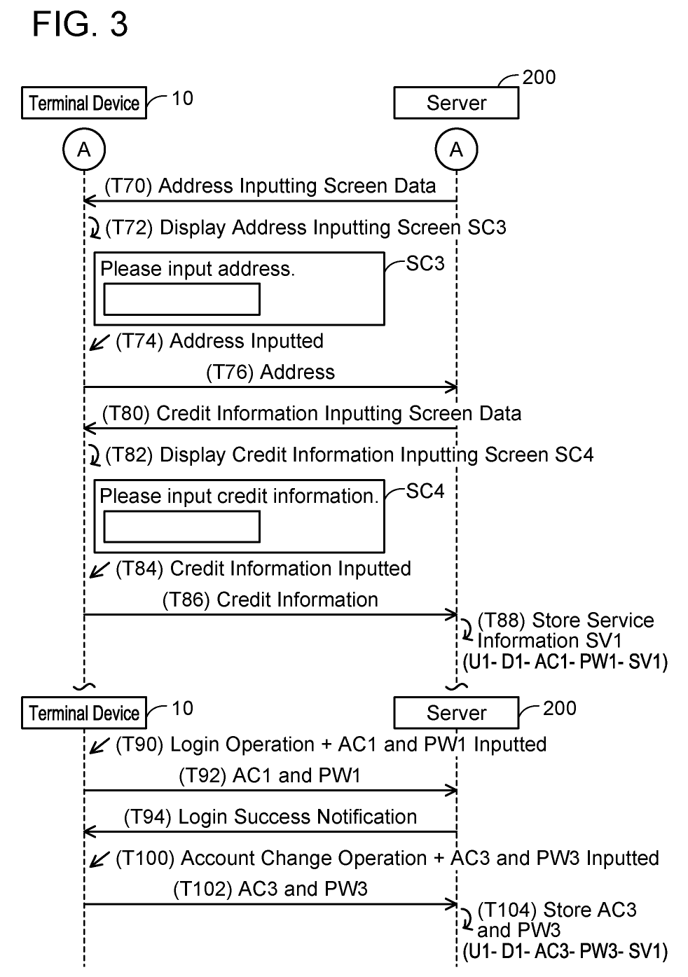

### Continuation of FIG. 2: FIG. 3

In T66, the server 200 receives information indicating the Light plan from the terminal device 10. In this case, the server 200 sends address inputting screen data representing an address inputting screen SC3 to the terminal device 10 in T70 in FIG. 3.

When the terminal device 10 receives the address inputting screen data from the server 200 in T70, the terminal device 10 displays the address inputting screen SC3 on the display unit 14 in T72. The address inputting screen SC3 includes an input field for inputting an address.

The terminal device 10 receives the input of an address in T74. In this case, the terminal device 10 sends information indicating the address to the server 200 in T76.

The server 200 receives the information indicating the address from the terminal device 10 in T76. In this case, the server 200 sends credit information inputting screen data representing a credit information inputting screen SC4 to the terminal device 10 in T80.

When the terminal device 10 receives the credit information inputting screen data from the server 200 in T80, the terminal device 10 displays the credit information inputting screen SC4 on the display unit 14 in T82. The credit information inputting screen SC4 includes an input field for inputting credit information including a credit card number, expiration date, for example.

The terminal device 10 receives the input of the credit information in T84. In this case, the terminal device 10 sends the credit information to the server 200 in T86.

The server 200 receives the credit information from the terminal device 10 in T86. In this case, the server 200 stores service information SV1 in the account table 238 in T88. Here, the server 200 stores the service information SV1 in association with the unique ID “U1” received in T26 in FIG. 2 and the device ID “D1” received in T42 in FIG. 2. The service information SV1 includes the information indicating the Light plan received in T66, the information indicating the address received in T76, and the credit information received in T86.

When the server 200 stores the service information SV1, the server 200 starts providing the flat-rate printing service to the user of the terminal device 10 and the printer 100. Specifically, the server 200 first executes processing to dispatch color material cartridge(s) being exclusive for the flat-rate printing service to the address included in the service information SV1. Thereafter, the server 200 periodically receives the amount(s) of remaining color material(s) from the printer 100 and executes processing to dispatch a new color material cartridge when the amount of a remaining color material falls below a threshold value. The server 200 also periodically receives an accumulated number of sheets printed from the printer 100, and when the end of a predetermined period, such as one month, arrives, the server 200 calculates the number of sheets printed for that predetermined period. If the calculated number of printed sheets is equal to or less than the upper-limit number of sheets for the Light plan, the server 200 charges the basic fee for the Light plan based on the credit information included in the service information SV1. If the calculated number of sheets printed is equal to or more than the upper-limit number of sheets for the Light plan, the server 200 charges the total of the Light plan basic fee and the excess fee. In this way, the server 200 can provide users with the flat-rate printing service.

As mentioned above, the account information “AC1” and “PW1” notified to the user in T30 in FIG. 2 is not determined by the user. If the user wishes to change the account information, the user performs the following operations.

The terminal device 10 receives an operation to start the browser application 38 from the user. Next, the terminal device 10 receives a login operation to log in to the server 200 in T90. The login operation includes, in addition to the access operation of T10 in FIG. 2, an operation to display a login screen. The terminal device 10 then receives an operation to input the account information “AC1” and “PW1” on the login screen. In this case, the terminal device 10 sends the account information “AC1” and “PW1” to the server 200 in T92.

The server 200 receives the account information “AC1” and “PW1” from the terminal device 10 in T92. In this case, the server 200 sends a login success notification to the terminal device 10 in T94.

When the terminal device 10 receives the login success notification from the server 200 in T94, the terminal device 10 receives an account change operation from the user in T100. The account change operation includes an operation to display an account change screen. The terminal device 10 then receives input of a new account ID “AC3” and a new password “PW3” on the account change screen. In this case, the terminal device 10 sends the new account information “AC3” and “PW3” to the server 200 in T102.

The server 200 receives the new account information “AC3” and “PW3” from the terminal device 10 in T102. In this case, the server 200 stores the new account information “AC3” and “PW3” in the account table 238 instead of the old account information “AC1” and “PW1” in T104. Due to this, the new account information “AC3” and “PW3” determined by the user is registered on the server 200. Therefore, the user can log in to the server 200 using the new account information “AC3” and “PW3” from now on.

### Processing of Case B: FIG. 4

Next, referring to FIG. 4, Case B in which a user operates the printer 100 first and then the terminal device 10 in order to subscribe to the flat-rate printing service will be described.

First, in T110, the printer 100 receives an operation to select the flat-rate printing service, i.e., the service subscription operation from the user. T110 is the same as T40 in FIG. 2. The printer 100 sends the device ID “D1” of the printer 100 to the server 200 in T112.

The server 200 receives the device ID “D1” from the printer 100 in T112. In this case, the server 200 first checks whether the server 200 has already received the unique ID “U1” associated with the device ID “D1” from the terminal device 10. This check is same as the check performed by the server 200 according to T42 in FIG. 2. In this Case B, the server 200 has not already received the unique ID “D1”. In this case, the server 200 temporarily stores the device ID “D1” and a date and time T2 when the device ID “D1” was received in association with each other in the memory 234 in T114.

Next, processing from T120 to T136 is executed by the user using the terminal device 10. T120 to T136 are the same as T10 to T26 in FIG. 2.

When the server 200 receives the unique ID “U1” from the terminal device 10 in T136, the server 200 first checks whether the server 200 has already received the device ID “D1” associated with the unique ID “U1” from the printer 100. This check is same as the check performed by the server 200 according to T26 in FIG. 2. In this Case B, the device ID “D1” has already been stored in the memory 234 in T114. That is, the server 200 has already received the device ID “D1”. In this case, the server 200 proceeds to T140.

In T140, the server 200 specifies the account information “AC1” and “PW1” associated with the unique ID “U1” from the account table 238. The server 200 then sends the account information “AC1” and “PW1” to the terminal device 10.

The terminal device 10 receives the account information “AC1” and “PW1” from the server 200 in T140. In this case, the terminal device 10 displays the account information “AC1” and “PW1” on the display unit 14 in T142. T142 is the same as T32 in FIG. 2.

Next, in T150, the server 200 determines whether a difference time between the current date and time and the received date and time T2 (date and time of receipt T2) stored in T114 is smaller than a predetermined time. That is, the server 200 determines whether the unique ID “U1” was received before the predetermined time elapsed since the device ID “D1” was received. When the difference time is equal to or less than the predetermined time, the server 200 determines YES in T150 and proceeds to T160. In this case, the server 200 sends plan selection screen data representing the plan selection screen SC2 to the terminal device 10 in T160. Contrary to this, when the difference time is greater than the predetermined time, the server 200 determines NO in T150 and ends the processing without executing the series of processing from T160. In this case, the server 200 erases the device ID “D1” and the received date and time T2 stored in T114 from the memory 234.

If a long time is required from the receipt of the device ID “D1” to the receipt of the unique ID “U1”, the server 200 does not execute the series of processing from T160. That is, since the server 200 employs a timeout, an event in which the user is made to subscribe to the flat-rate printing service against the user's intention can be suppressed from occurring. In a modification, the server 200 may erase the device ID “D1” and the received date and time T2 from the memory 234 after a predetermined time elapses since the device ID “D1” was stored in T140. This configuration can also suppress an event in which the user is made to subscribe to the flat-rate printing service against the user's intention from occurring.

T160 to T166 are the same as T60 to T66 in FIG. 2. After that, the processing in T70 to T88 of FIG. 3 is executed, and the subscription to the flat-rate printing service ends. After that, when the processing of T90 to T104 in FIG. 3 is executed, and the new account information is registered with the server 200.

As shown in case A in FIG. 2, when the server 200 receives the unique ID “U1” from the terminal device 10 first (T26) and thereafter receives the device ID “D1” from the printer 100 (T42), the server 200 can send the screen data for subscribing to the flat-rate printing service to the terminal device 10 (T60). As shown in Case B in FIG. 4, when the server 200 receives the device ID “D1” from the printer 100 first (T112) and thereafter receives the unique ID “U1” from the terminal device 10 (T136), the server 200 can also send the screen data for subscribing to the flat-rate printing service to the terminal device 10 (T160). Thus, the user can subscribe to the flat-rate printing service both when operating the terminal device 10 first and when operating the printer 100 first.

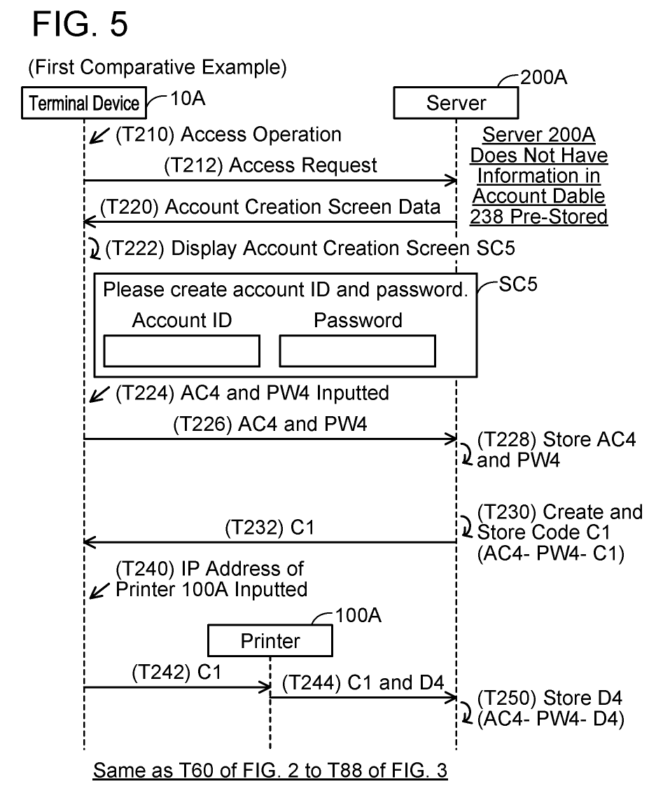

### First Comparative Example: FIG. 5

The first comparative example will be described with reference to FIG. 5. In the first comparative example, processing is performed by a terminal device 10A, a printer 100A, and a server 200A. In the first comparative example, a unique ID is not used. In addition, the server 200A does not store device ID(s) and account information in advance in an account table (not shown).

When the terminal device 10A receives an access operation from a user in T210, the terminal device 10A sends an access request to the server 200A in T212.

The server 200A receives the access request from the terminal device 10A in T212. In this case, the server 200A sends account creation screen data representing an account creation screen SC5 to the terminal device 10A in T220.

When the terminal device 10A receives the account creation screen data from the server 200A in T220, the terminal device 10A displays the account creation screen SC5 in T222. The account creation screen SC5 includes an input field for specifying an account ID and an input field for specifying a password. The terminal device 10A receives an operation to input an account ID “AC4” and a password “PW4” from the user in T224. In this case, the terminal device 10A sends account information “AC4” and “PW4” to the server 200A in T226.

The server 200A receives the account information “AC4” and “PW4” from the terminal device 10A in T226. In this case, the server 200A temporarily stores the account information “AC4” and “PW4” in T228. The server 200A creates a code C1 and temporarily stores the code C1 in association with the account information “AC4” and “PW4” in T230. Next, the server 200A sends the code C1 to the terminal device 10A in T232.

Although not shown in the figures, the user then moves closer to the printer 100A and operates the printer 100A. Due to this, the user causes the printer 100A to display or print the IP address of the printer 100A. The terminal device 10A then receives an operation to input the IP address from the user in T240. The terminal device 10A uses the IP address to access printer 100A and receives an operation to subscribe to the flat-rate printing service. In this case, the terminal device 10A sends the code C1 to the printer 100A in T242.

The printer 100A receives the code C1 from the terminal device 10A in T242. In this case, the printer 100A sends the code C1 and a device ID “D4” of the printer 100A to the server 200A in T244.

The server 200A receives the code C1 and the device ID “D4” from the printer 100A in T244. In this case, the server 200A first specifies the account information “AC4” and “PW4” temporarily stored in association with the code C1. Then, in T250, the server 200A stores the account information “AC4” and “PW4” with the device ID “D4” in the account table. Thereafter, the same processing as T60 to T66 in FIG. 2 and T70 to T88 in FIG. 3 is executed.

In the first comparative example, the user needs to determine and input the account information “AC4” and “PW4” into the terminal device 10A (T224) before inputting substantive information required to subscribe to the flat-rate printing service, namely, the service plan, address, and credit information. In contrast, according to the present embodiment, the server 200 stores the unique ID “U1”, the device ID “D1”, and the account information “AC1” and “PW1” in association with each other in advance. Due to this, the user does not have to determine and input the account information into the terminal device 10 before inputting the substantive information. This can improve user convenience.

In the first comparative example, the user needs to input the IP address of the printer 100A into the terminal device 10A. That is, the user needs to execute two times of input of a character string, that are the input of account information and the IP address of the printer 100A, before the input of substantive information. In contrast, according to the present embodiment, as shown in FIGS. 2 or 4, the user only needs to input the unique ID “U1” into the terminal device 10 before inputting the substantive information (T24, T134). That is, the user needs to input a character string into the terminal device 10 only once before inputting the substantive information. This can improve user convenience.

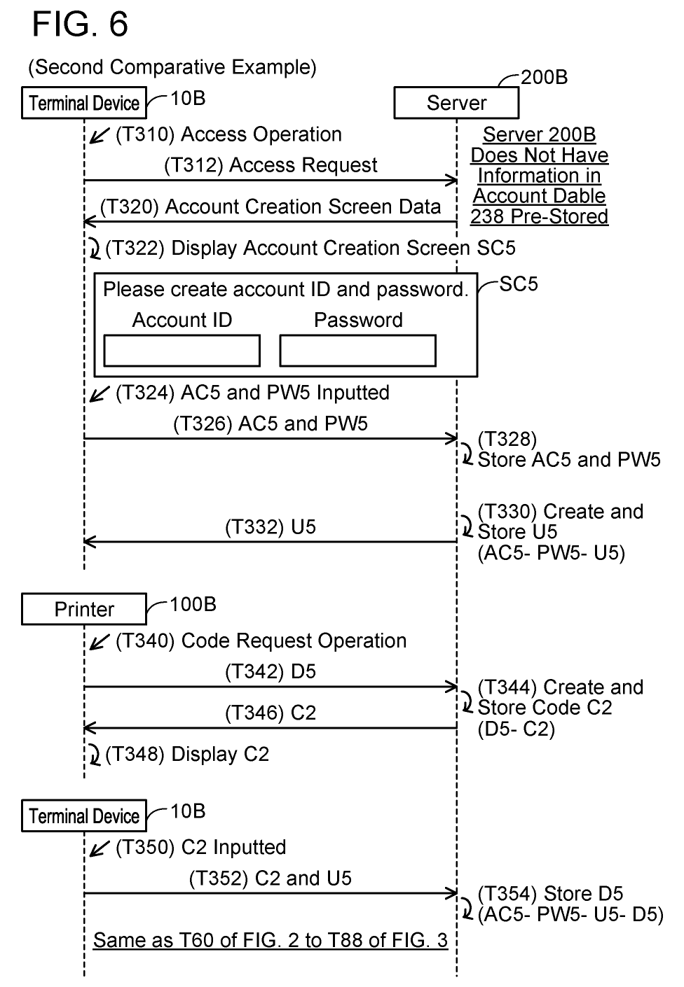

### Second Comparative example: FIG. 6

Next, a second comparative example will be described with reference to FIG. 6. In the second comparative example, processing is performed by a terminal device 10B, a printer 100B, and a server 200B. In the second comparative example, a unique ID is used, but the server 200B does not store unique ID(s), device ID(s), and account information in advance in an account table (not shown).

T310 to T322 are the same as T210 to T222 in FIG. 5 of the first comparative example. The terminal device 10B receives an operation to input an account ID “AC5” and a password “PW5” from a user in T324. In this case, the terminal device 10B sends account information “AC5” and “PW5” to the server 200B in T326.

The server 200B receives the account information “AC5” and “PW5” from the terminal device 10B in T326. In this case, the server 200B temporarily stores the account information “AC5” and “PW5” in T328. The server 200B creates a unique ID “U5” and temporarily stores the unique ID “U5” in association with the account information “AC5” and “PW5” in T330. Next, the server 200B sends the unique ID “U5” to the terminal device 10B in T332.

The user then moves closer to the printer 100B and operates the printer 100B. The printer 100B then receives a code request operation from the user in T340. In this case, the printer 100B sends a device ID “D5” of the printer 100B to the server 200B in T342.

The server 200B receives the device ID “D5” from the printer 100B in T342. In this case, in T344, the server 200B creates a code C2 and temporarily stores the device ID “D5” and the code C2 in association with each other. The server 200B then sends the code C2 to the printer 100B in T346.

When the printer 100B receives the code C2 from the server 200B in T346, the printer 100B displays the code C2 in T348. This allows the user to know the code C2.

Next, the user operates the terminal device 10B. The terminal device 10B receives an input of the code C2 from the user in T350. In this case, in T352, the terminal device 10B sends the code C2 and the unique ID “U5” already received in T332 to the server 200B.

The server 200B receives the code C2 and the unique ID “U5” from the terminal device 10B in T352. In this case, the server 200B first specifies the account information “AC5” and “PW5” temporarily stored in association with the unique ID “U5”. The server 200B further specifies the device ID “D5” temporarily stored in association with the code C2. The server 200B stores the account information “AC5” and “PW5”, the unique ID “U5”, and the device ID “D5” in the account table in T354. Thereafter, the same processing as T60 to T66 in FIG. 2 and T70 to T88 in FIG. 3 is executed.

In the second comparative example, the user needs to determine and input the account information “AC5” and “PW5” into the terminal device 10 before inputting substantive information required to subscribe to the flat-rate printing service, namely, the service plan, address, and credit information. In contrast, according to the present embodiment, the server 200 stores the unique ID “U1”, device ID “D1”, and account information “AC1” and “PW1” in advance in association with each other. Due to this, the user does not have to determine and input the account information into the terminal device 10 before inputting the substantive information. This can improve user convenience.

Also, in the second comparative example, the user needs to input the code C2 into the terminal device 10B. That is, the user needs to execute two times of input of a character string, the input of the account information and the input of the code, before the input of substantive information. In contrast, according to the present embodiment, as shown in FIGS. 2 or 4, the user only needs to input the unique ID “U1” into the terminal device 10 before inputting the substantive information (T24, T134). That is, the user needs to input the character string into the terminal device 10 only once before inputting the substantive information. This can improve user convenience.

### Effect of Embodiment

According to the above configuration, as shown in the account table 238, the server 200 stores the unique ID, and device ID, and account information in association with each other for each of the plurality of printers. Therefore, the server 200 can send the screen data for subscribing to the flat-rate printing service to the terminal device 10 without receiving registration of user account information from the user (e.g., T60 in FIG. 2). In other words, the user can subscribe to the flat-rate printing service without having to perform the processing for registering user account information with the server 200. This situation is clearer when comparing the present embodiment with the first and second comparative examples. Thus, user convenience can be improved.

### Correspondence Relationships

The printer 100 is an example of “specific image processing device”. The unique ID is an example of “unique identification information” and “U1” is an example of "specific unique identification information”. The device ID is an example of “device identification information” and “D1” is an example of “specific device identification information”. The account ID and password are an example of “user account information”, and “AC1” and “PW1” are an example of “specific user account information”. The plan selection screen SC2, the address inputting screen SC3, and the credit information inputting screen SC4 are examples of “service screen”. The service subscription operation of T40 in FIG. 2 and T110 in FIG. 4 are examples of “predetermined operation”. The predetermined time of T50 in FIG. 2 is an example of “first predetermined time”. The predetermined time of T150 in FIG. 4 is an example of “second predetermined time”.

Correspondence relationship in “server” is as follows. T26 in FIG. 2 and T136 in FIG. 4 are examples of “receive the specific unique identification information”. T42 in FIG. 2 and T112 in FIG. 4 are examples of “receive specific device identification information” and “receive the specific device identification information”. T60 in FIG. 2, T70 in FIG. 3, and T80 in FIG. 3 are examples of “send service screen information”. T30 in FIG. 2 and T140 in FIG. 4 are examples of “specify specific account information associated with the specific unique identification information from the memory and send the specific account information”. T104 in FIG. 3 is an example of “change the specific account information to account information designated by the user”.

Correspondence relationship in “terminal device” and “specific image processing device” is as follows. T26 in FIG. 2 and T136 in FIG. 4 are examples of “send the specific unique identification information” of the “terminal device”. T42 in FIG. 2 and T112 in FIG. 4 are examples of “send specific device identification information” of the “specific image processing device”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(Modification 1) The “image processing device” is not limited to a printer, but may also be a scanner configured to scan. The “image processing device” may also be a multifunctional machine configured to perform multiple functions including printing and scanning functions. In other words, the “image processing device” is a concept that includes any device configured to process an image, additionally including a PC, a smartphone, for example.
(Modification 2) The account table 238 may not store unique ID(s). In this case, the account ID “AC1” is notified to the user who purchased the printer 100 instead of the unique ID “U1”. The user inputs the account ID “AC1” instead of the unique ID “U1” into the terminal device 10 in T24 in FIG. 2. The terminal device 10 sends the account ID “AC1” to the server 200 in T26. The server 200 sends the password “PW1” to the terminal device 10 in T30. When the server 200 receives the device ID “D1” from the printer 100 in T42, the server 200 determines that the account ID “AC1” and the device ID “D1” are stored in association with each other in the account table 238. In this case, the server 200 sends the plan selection screen data to the terminal device 10 in T60. In this modification, the account ID is used as the unique ID. In general terms, the “memory” may not store the unique identification information, the device identification information, and the user account information in association with each other.
(Modification 3) T30 in FIG. 2 and T140 in FIG. 4 can be omitted. In this modification, “specify specific account information associated with the specific unique identification information from the memory and send the specific account information” can be omitted. In this modification, the user cannot change the account information because the user is unable to know the account information. That is, the processing from T90 to T104 in FIG. 3 can also be omitted. In this modification, “change the specific account information to account information designated by the user” can be omitted.
(Modification 4) T50 in FIG. 2 can be omitted. That is, the server 200 may perform the processing of T60 when the device ID “D1” is received after a predetermined time has elapsed since the unique ID “U1” was received. In general terms, “send service screen information” may include sending the service screen information to the terminal device when the specific device identification information is received from the specific image processing device after the first predetermined time has elapsed since the specific unique identification information was received from the terminal device.
(Modification 5) T150 in FIG. 4 can be omitted. That is, the server 200 may perform the processing of T160 when the unique ID “U1” is received after a predetermined time has elapsed since the device ID “D1” was received. In general terms, “send service screen information” may include sending the service screen information to the terminal device when the specific unique identification information is received from the terminal device after the second predetermined time has elapsed since the specific device identification information was received from the specific image processing device.
(Modification 6) The server 200 may be capable of realizing only one of the cases of Case A in FIG. 2 and Case B in FIG. 4. That is, the server 200 may send the screen data to the terminal device 10 when the server 200 receives the unique ID before the device ID, but may not send the screen data to the terminal device 10 when the server 200 receives the device ID before the unique ID. Conversely, the server 200 may send the screen data to the terminal device 10 when the server 200 receives the device ID before the unique ID, but may not send the screen data to the terminal device 10 when the server 200 receives the unique ID before the device ID. In general terms, “send service screen information” may not include sending the service screen information to the terminal device when the specific device identification information is received from the specific imaging device after the specific unique identification information has been received from the terminal device. Likewise, “send service screen information” may not include sending the service screen information to the terminal device when the specific unique identification information is received from the terminal device after the specific device identification information has been received from the specific image processing device.
(Modification 7) “Service” is a concept that is not limited to services related to printing, but may include various other services. For example, when a scanner is an example of “image processing device”, the “service” may include a cloud scanning service that enables a scanner to perform scanning via a server. When a smartphone is an example of “image processing device”, the “service” may include an IP phone service that enables IP phone communication.
(Modification 8) In the above embodiments, each of the processing in FIGS. 2-4 is realized by software, but at least one of these processing may be realized by hardware such as a logic circuitry.

What is claimed is:

1. A server comprising:
a memory configured to store, for each of a plurality of image processing devices, unique identification information assigned by a vendor of the image processing device and device identification information identifying the image processing device in association with each other, and store, for each of the plurality of image processing devices, user account information assigned by a vendor of the image processing device, and
a controller,
wherein the controller is configured to:
in a case where specific unique identification information is inputted to a terminal device, receive the specific unique identification information from the terminal device;
in a case where a predetermined operation is executed on a specific image processing device among the plurality of image processing devices, receive specific device identification information identifying the specific image processing device from the specific image processing device; and
in a case where the specific unique identification information is received from the terminal device, the specific device identification information is received from the specific image processing device, and the specific unique identification information and the specific device identification information are stored in the memory in association with each other, send service screen information representing a service screen for subscribing to a service provided by the server to the terminal device.

2. The server as in claim 1,
wherein the memory is configured to store, for each of the plurality of image processing devices, the unique identification information, the device identification information, and the user account information in association with each other.

3. The server as in claim 1,
wherein the controller is further configured to:
in a case where the specific unique identification information is received from the terminal device, specify specific account information associated with the specific unique identification information from the memory and send the specific account information to the terminal device.

4. The server as in claim 1,
wherein the controller is configured to receive the specific unique identification information from the terminal device before the specific device identification information is received from the specific image processing device.

5. The server as in claim 4,
wherein before a first predetermined time elapses since the specific unique identification information was received from the terminal device, in a case where the specific device identification information is received from the specific image processing device and the specific unique identification information and the specific device identification information are stored in association with each other in the memory, the controller is configured to send the service screen information to the terminal device, and
after the first predetermined time has elapsed since the specific unique identification information was received from the terminal device, in a case where the specific device identification information is received from the specific image processing device, the controller is configured not to send the service screen information to the terminal device.

6. The server as in claim 1,
wherein, before the specific unique identification information is received from the terminal device, the controller is configured to receive the specific device identification information from the specific image processing device.

7. The server as in claim 6,
wherein, before a second predetermined time elapses since the specific device identification information was received from the specific image processing device, in a case where the specific unique identification information is received from the terminal device and the specific unique identification information and the specific device identification information are stored in association with each other in the memory, the controller is configured to send the service screen information to the terminal device, and
after the second predetermined time has elapsed since the specific device identification information was received from the specific image processing device, in a case where the specific unique identification information is received from the terminal device, the controller is configured not to send the service screen information to the terminal device.

8. The server as in claim 1,
wherein, after the specific unique identification information has been received from the terminal device, in a case where the specific device identification information is received from the specific image processing device and the specific unique identification information and the specific device identification information are stored in association with each other in the memory, the controller is configured to send the service screen information to the terminal device, and
after the specific device identification information has been received from the specific image processing device, in a case where the specific unique identification information is received from the terminal device and the specific unique identification information and the specific device identification information are stored in association with each other in the memory, the controller is configured to send the service screen information to the terminal device.

9. The server as in claim 1,
wherein the controller is further configured to:
after the controller has completed subscribing to the service, in a case where a login using the specific account information is executed and a change request of the specific account information is received, change the specific account information to account information designated by the user.

10. A method executed by a server, wherein the server comprises:
a memory configured to store, for each of a plurality of image processing devices, unique identification information assigned by a vendor of the image processing device and device identification information identifying the image processing device in association with each other, and store, for each of the plurality of image processing devices, user account information assigned by a vendor of the image processing device,
the method comprising:
in a case where specific unique identification information is inputted to a terminal device, receiving the specific unique identification information from the terminal device;
in a case where a predetermined operation is executed on a specific image processing device among the plurality of image processing devices, receiving specific device identification information identifying the specific image processing device from the specific image processing device; and
in a case where the specific unique identification information is received from the terminal device, the specific device identification information is received from the specific image processing device, and the specific unique identification information and the specific device identification information are stored in the memory in association with each other, sending service screen information representing a service screen for subscribing to a service provided by the server to the terminal device.

11. A communication system comprising:
a server;
a terminal device; and
a specific image processing device,
wherein the server comprises:
a memory configured to store, for each of a plurality of image processing devices including the specific image processing device, unique identification information assigned by a vendor of the image processing device and device identification information identifying the image processing device in association with each other, and store, for each of the plurality of image processing devices including the specific image processing device, user account information assigned by a vendor of the image processing device,
wherein the terminal device comprises a terminal controller configured to, in a case where specific unique identification information is inputted to the terminal device, send the specific unique identification information to the server,
wherein the specific image processing device comprises a device controller configured to, in a case where a predetermined operation is executed on the specific image processing device, send specific device identification information identifying the specific image processing device to the server,
wherein the server further comprises a server controller configured to:
receive the specific unique identification information from the terminal device;
receive the specific device identification information from the specific image processing device; and
in a case where the specific unique identification information is received from the terminal device, the specific device identification information is received from the specific image processing device, and the specific unique identification information and the specific device identification information are stored in the memory in association with each other, send service screen information representing a service screen for subscribing to a service provided by the server to the terminal device.
